(19) United States
(12) Patent Application Publication
(10) Pub. No.: US 2026/0221886 A1
(43) Pub. Date: Jul. 30, 2026

(54) Integrated Power Supply Device and Control Method for Integrated Power Supply Device

(71) Applicant: Astemo, Ltd., Chiyoda-ku, Tokyo (JP)

(72) Inventors: Yoshinori KURIMOTO, Tokyo (JP); Takae SHIMADA, Tokyo (JP); Mizuki NAKAHARA, Tokyo (JP); Tomoki SAKABE, Tokyo (JP); Hideki MIYAZAKI, Hitachinaka-shi, Ibaraki (JP); Yoshihito YASUKAWA, Hitachinaka-shi, Ibaraki (JP)

(21) Appl. No.: 19/159,120

(22) PCT Filed: Apr. 25, 2024
(86) PCT No.: PCT/JP2024/016214

§ 371 Date: Aug. 22, 2025

(30) Foreign Application Priority Data
May 19, 2023 (JP) 2023-082832

(51) Int. Cl. H02M 3/335; H02J 7/00; H02J 7/02; H02M 1/00; H02M 3/00

(52) U.S. Cl. CPC H02M 3/33573; H02J 7/02; H02J 7/855; H02M 1/0048; H02M 3/01; H02M 3/33561; H02M 3/33584; H02J 2207/20

(57) ABSTRACT

Provided is an integrated power supply device in which AC sides of three or more DC/AC circuits are coupled by a transformer having three or more windings. The integrated power supply device is capable of correctly outputting power in all assumed driving modes (power directions) and reducing a loss without adding a discharge device. In the integrated power supply device in which AC sides of three or more DC/AC circuits are coupled by a transformer having three or more windings, the three or more DC/AC circuits include a first DC/AC circuit that includes a first switching circuit and a capacitor connected in parallel to the first switching circuit and a second DC/AC circuit that includes a second switching circuit connected to a power storage unit. When power is supplied from the second DC/AC circuit to a load connected to a DC/AC circuit other than the first DC/AC circuit and the first switching circuit is unloaded or a connected load is equal to or less than a predetermined power consumption value, the first switching circuit is switched to provide a period for supplying power from the capacitor to the first switching circuit along with switching of the second switching circuit.

### TECHNICAL FIELD

The present invention relates to a configuration of a power supply device and a control method for the power supply device, and particularly relates to an effective technique applied to an integrated power supply device in which AC sides of three or more DC/AC circuits are coupled by a transformer having three or more windings.

### BACKGROUND ART

Isolated DC/DC converters that isolate and output stabilized voltages from wide input voltage ranges are widely used as in-vehicle power conversion circuits, information communication devices such as base stations or routers, and power conversion circuits for servers.

In recent years, efforts have been made to achieve miniaturization, weight reduction, and multi-functionality of circuits by further coupling other circuits to transformers of the isolated DC/DC converters.

For example, in the in-vehicle field, in order to miniaturize in-vehicle power supplies, development of integrated power supply devices in which in-vehicle chargers (onboard battery chargers (OBC)), DC/AC converters for vehicle-to-load (V2L) outlets, and auxiliary battery circuits are integrated by multi-winding transformers is underway.

As background art of the present technical field, for example, there is a technique such as PTL 1. PTL 1 discloses “a power conversion device that supplies power to a plurality of loads via a multi-winding transformer”.

In PTL 1, an AC power supply 1 such as a commercial AC power supply or a private power generator, a first DC voltage source 2 such as a high-voltage battery for vehicle traveling, a second DC voltage source 3 such as a lead battery that is a power supply (LV) of vehicle electrical components, and an inverter 4 that is applicable to a system (V2L) using an AC 100V power supply that can be used in the vehicle are coupled by a composite winding transformer 10. (FIG. 1, paragraph [0011], and the like of PTL 1)

### Citation List

### Patent Literature

PTL 1: JP 2016-146681 A

### SUMMARY OF INVENTION

### Technical Problem

An integrated circuit as described in PTL 1 is effective in reducing the size and weight of the circuit because a bridge circuit can be connected to each winding of the multi-winding transformer to reduce the number of circuit elements.

However, when an on-board charger (OBC) is integrated, a switching circuit related only to an OBC is not used (that is, no load is applied) when the OBC is not used, such as when a vehicle is traveling. However, the switching circuits are coupled to each other in a transformer. Therefore, even if an unloaded switching circuit is turned off, an output capacitance of a switch, a leakage inductance of the transformer, and a diode perform a boosting circuit operation, which results in overcharging of an unloaded DC unit.

In PTL 1, only the LV circuit and the V2L circuit are used. When the OBC is not used, the bridge circuit on the OBC side is turned off. In this case, since the DC unit of the turned-off circuit is likely to be overcharged due to an influence of the LV or the V2L power supply, a discharge device such as a discharge resistor is separately required.

Accordingly, an object of the present invention is to provide an integrated power supply device in which AC sides of three or more DC/AC circuits are coupled by a transformer having three or more windings and which is capable of correctly outputting power in all assumed driving modes (power directions) without an additional discharge device and reducing a loss, and a control method for the integrated power supply device.

### Solution to Problem

In order to solve the above problems, the present invention provides an integrated power supply device in which AC sides of three or more DC/AC circuits are coupled by a transformer having three or more windings. The three or more DC/AC circuits include a first DC/AC circuit that includes a first switching circuit and a capacitor connected in parallel to the first switching circuit and a second DC/AC circuit that includes a second switching circuit connected to a power storage unit. When power is supplied from the second DC/AC circuit to a load connected to a DC/AC circuit other than the first DC/AC circuit and the first switching circuit is unloaded or a connected load is equal to or less than a predetermined power consumption value, the first switching circuit is switched to provide a period for supplying power from the capacitor to the first switching circuit along with switching of the second switching circuit.

Further, the present invention provides a control method for an integrated power supply device in which AC sides of three or more DC/AC circuits including a first DC/AC circuit on a primary side and a second DC/AC circuit on a secondary side are coupled by a transformer having three or more windings. When power is supplied from the second DC/AC circuit to a load connected to a DC/AC circuit other than the first DC/AC circuit and the first switching circuit of the first DC/AC circuit is unloaded or a connected load is equal less than a predetermined power consumption value, the first switching circuit is switched to provide a period for supplying power from a capacitor connected in parallel to the first switching circuit to the first switching circuit along with switching of the second switching circuit of the second DC/AC circuit.

### Advantageous Effects of Invention

According to the present invention, in an integrated power supply device in which the AC sides of three or more DC/AC circuits are coupled by a transformer having three or more windings, it is possible to implement an integrated power supply device capable of correctly outputting power in all assumed driving modes (power directions) and reducing a loss without an additional discharge device, and a control method for the integrated power supply device.

Accordingly, it is possible to contribute to miniaturization, weight reduction, and increase in efficiency of the integrated power supply device.

Problems, configurations, and effects other than those described above will be clarified by the following description of embodiments.

### BRIEF DESCRIPTION OF DRAWINGS

FIG. 1 is a diagram illustrating a schematic configuration of a bidirectional charging device according to a first embodiment of the present invention.

FIG. 2 is a timing chart illustrating operations of the switching circuit 1 and the switching circuit 2 of FIG. 1.

FIG. 3A is a diagram schematically illustrating operation of the switching circuit 1 of FIG. 1.

FIG. 3B is a diagram schematically illustrating operation of the switching circuit 1 of FIG. 1.

FIG. 3C is a diagram schematically illustrating operation of the switching circuit 1 of FIG. 1.

FIG. 4A is a diagram illustrating a control method for switching element Q1 (Q2) in FIG. 1.

FIG. 4B is a view illustrating a control method for the switching element Q1 (Q2) in FIG. 1.

FIG. 5 is a timing chart illustrating operations of a switching circuit 1 and a switching circuit 2 according to a second embodiment of the present invention.

FIG. 6 is a diagram schematically illustrating an operation of a switching circuit 1 according to a second embodiment of the present invention.

### DESCRIPTION OF EMBODIMENTS

Hereinafter, embodiments of the present invention will be described with reference to the drawings. In the drawings, the same components are denoted by the same reference numerals, and the detailed description of repeated components will be omitted.

### First Embodiment

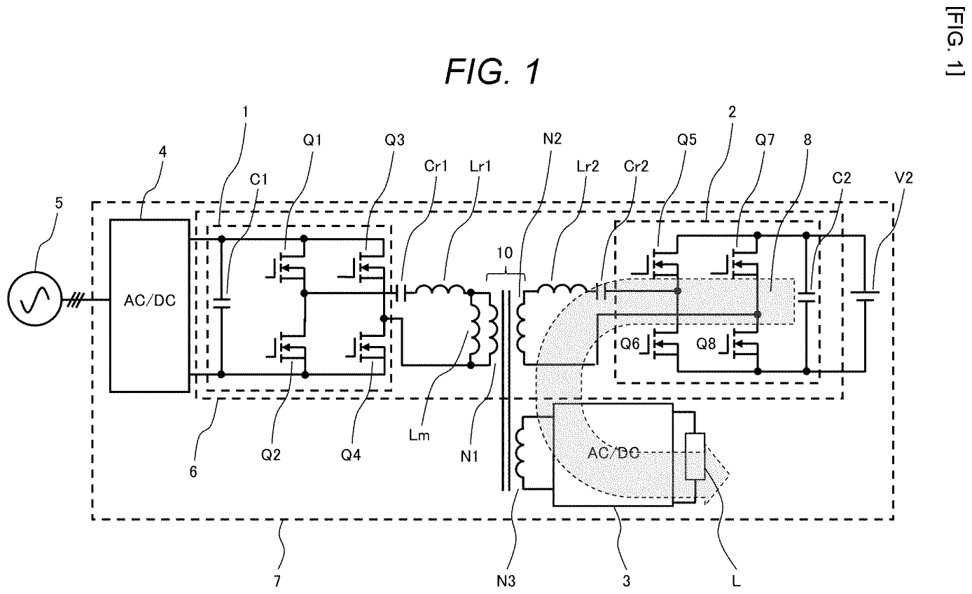

With reference to FIGS. 1 to 4B, an integrated power supply device and a control method therefor according to a first embodiment of the present invention will be described.

FIG. 1 is a diagram illustrating a schematic configuration of a bidirectional charging device 7 according to the present embodiment.

As illustrated in FIG. 1, the bidirectional charging device 7 according to the present embodiment includes a switching circuit 1, a switching circuit 2, an AC/DC circuit 3, an AC/DC converter 4, and a transformer 10 as main components. The switching circuit 1 is coupled to the primary side of the transformer 10 via a winding N1. The switching circuit 2 and the AC/DC circuit 3 are coupled to the secondary side of the transformer 10 via windings N2 and N3, respectively. The switching circuit 1, the switching circuit 2, and the transformer 10 form a DC/DC converter 6.

The AC/DC converter 4 is connected to the switching circuit 1, receives AC power from the AC power supply 5, converts the received AC power into DC power, and then supplies a DC voltage to a capacitor C1.

The DC/DC converter 6 converts a DC voltage applied to the capacitor C1 into a DC voltage applied to a capacitor C2 and a storage battery V2.

The bidirectional charging device 7 according to the present embodiment is an integrated charger including a winding N3 (winding with the number of windings of N3) added to a transformer 10 with an excitation inductance Lm having a winding N1 (winding with the number of windings of N1) and a winding N2 (winding with the number of windings of N2), which are components of a DC/DC converter 6, and an AC/DC circuit 3 connected to the winding N3.

The switching circuit 1 includes two switching legs in which switching elements Q1 and Q2 and switching elements Q3 and Q4 are connected in series, and a series circuit of a capacitor Cr1 and a reactor Lr1 is connected between an output (input) and a primary side of the transformer 10.

The switching circuit 2 includes two switching legs in which switching elements Q5 and Q6 and switching elements Q7 and Q8 are connected in series, and a series circuit of a capacitor Cr2 and a reactor Lr2 is connected between an input (output) and a secondary side of the transformer 10.

The reactors Lr1 and Lr2 may be a leakage inductance of the transformer 10. The DC/DC converter 6 may be a resonance type converter in which the capacitors Cr1 and Cr2 and the reactors Lr1 and Lr2 are used as resonance elements, or a phase shift and dual active bridge converter in which a capacitor is used as a DC cut element or there is no capacitor. It is assumed that the switching elements Q1 to Q8 are metal-oxide-semiconductor field-effect transistors (MOSFETs) or insulated gate bipolar transistors (IGBTs).

An arrow 8 in FIG. 1 indicates a flow of power in an operation of the bidirectional charging device 7 according to the present embodiment, and schematically indicates that power is supplied from the storage battery V2 to the load L and no power is supplied from the AC power supply 5.

An example of the bidirectional charging device 7 according to the present embodiment is an in-vehicle charger. In this case, the storage battery V2 corresponds to a lithium ion battery, the load L corresponds to an auxiliary battery or an inverter for an in-vehicle outlet, and power supply (arrow 8) from the lithium ion battery to the auxiliary battery or the inverter for the in-vehicle outlet corresponds to an operation during vehicle driving.

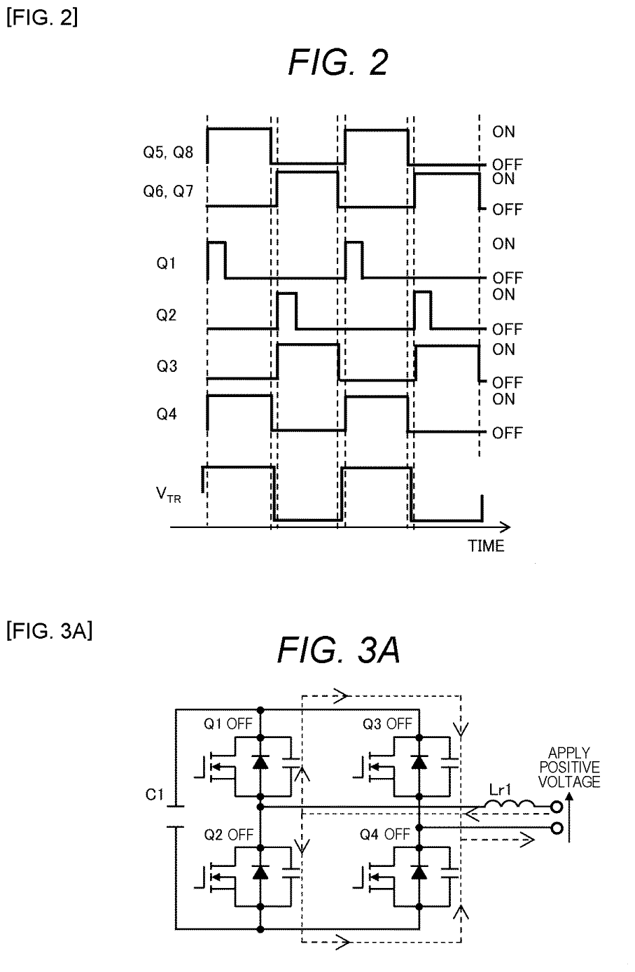

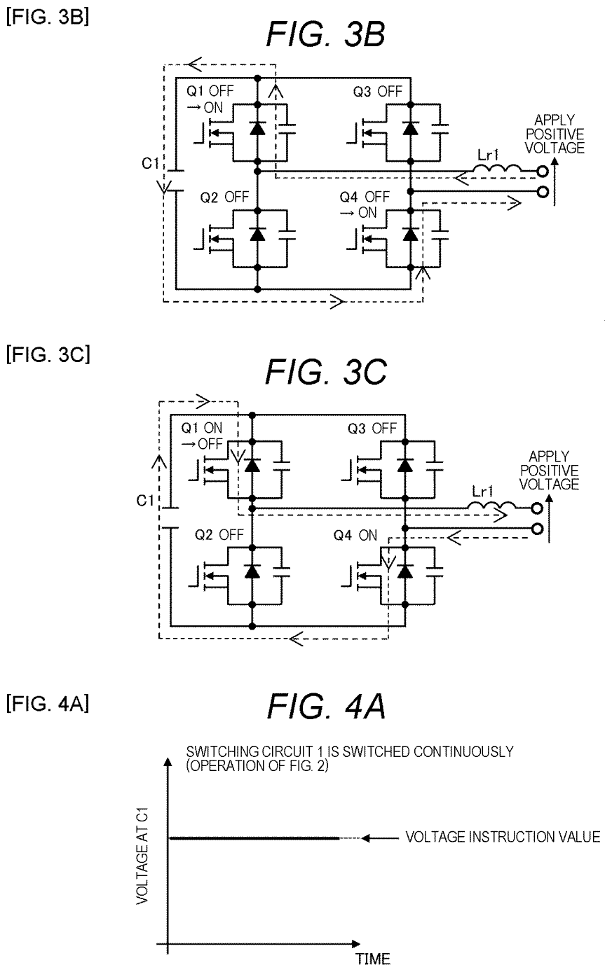

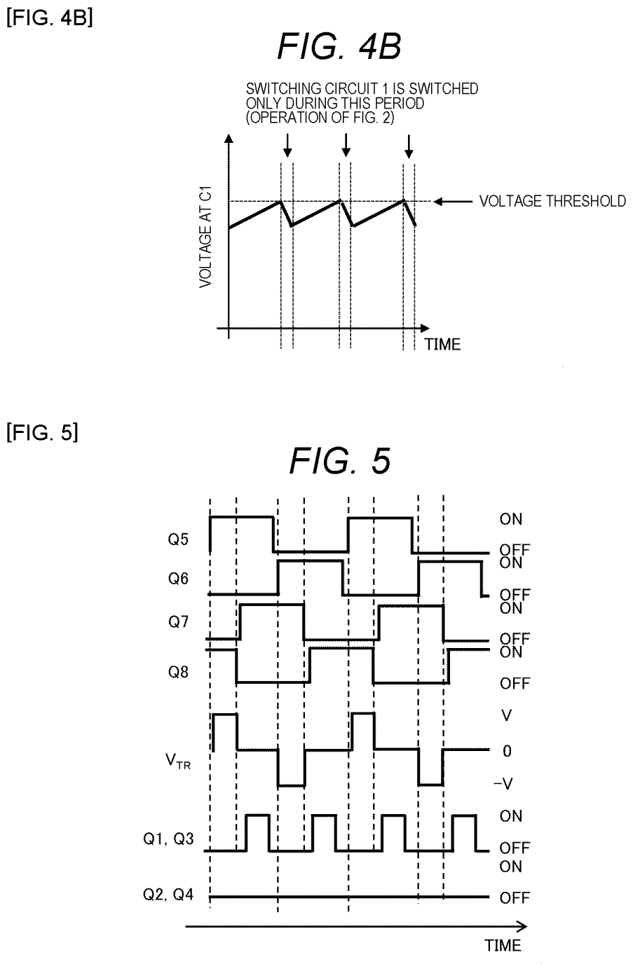

FIG. 2 is a timing chart illustrating operations of the switching circuits 1 and 2 in FIG. 1.

Q1 to Q8 indicate ON/OFF states of the switching elements Q1 to Q8, and VIR indicates a voltage applied to the transformer 10. As illustrated in FIG. 1, the switching elements Q5 to Q8 are switching elements for supplying power from the storage battery V2 to the load L.

In FIG. 2, the DC/DC converter 6 is assumed to be a resonance type converter, and the switching elements Q5 and Q8 and the switching elements Q6 and Q7 are simultaneously switched at a duty ratio of approximately 50%, but this is not necessarily the case. For example, a phase shift scheme of turning off Q5 earlier than Q8 and turning off Q6 earlier than Q7 may be used. A characteristic of the present embodiment is a relationship between a transformer-applied voltage VIR and the ON timings of the switching elements Q1 to Q4. That is, after a positive voltage is applied to the transformer 10, the switching elements Q1 and Q4 are turned on with a slight delay. After a negative voltage is applied to the transformer 10, the switching elements Q2 and Q3 are turned on with a slight delay.

This advantage will be described with reference to FIGS. 3A to 3C. FIGS. 3A to 3C are diagrams schematically illustrating an operation of the switching circuit 1 in FIG. 1.

FIG. 3A illustrates a current flow immediately after a positive voltage is applied to the transformer 10. Output capacitances of the switching elements Q2 and Q3 are charged and the switching elements Q1 and Q4 are discharged.

FIG. 3B illustrates a state in which a voltage of the switching element Q2 is higher than a sum of a voltage of the capacitor C1 and a forward voltage of a reverse diode of the switching element Q1, and the capacitor C1 is charged using the reactor Lr1 as a current source. This phenomenon is nothing but a problem to be solved in the present invention.

Accordingly, in the present embodiment, the switching elements Q1 and Q4 are turned on at a timing of FIG. 3B. At this timing, since the switching elements Q1 and Q4 are in a diode conduction state, the switching elements Q1 and Q4 are turned on at zero voltage, and a loss is small.

When the turn-on state continues, a direction of the current can be reversed by a rise in the voltage of the capacitor C1 as illustrated in FIG. 3C, and the capacitor C1 can be discharged. The length of this period, that is, a pulse width of the switching element Q1, determines an amount of discharge.

A state of FIG. 3C is implemented at the time of reverse recovery of the diode without turning on the switching elements Q1 and Q4. Accordingly, it can be said that the problem of overcharge of the capacitor C1 has been newly revealed due to advent of SiC and GaN, which are materials of next generation elements having a short reverse recovery time of the diode.

FIGS. 4A and 4B illustrate how to control a pulse width of the switching element Q1 (a pulse width of the switching element Q2 when a negative voltage is applied). FIG. 4A illustrates a scheme of controlling the pulse width so that the voltage of the capacitor C1 is constant. FIG. 4B illustrates a scheme of performing switching only when the voltage of the capacitor C1 exceeds a threshold.

As described above, the integrated power supply device (the bidirectional charging device 7) according to the present embodiment is an integrated power supply device in which AC sides of three or more DC/AC circuits are coupled by a transformer 10 having three or more windings. The three or more DC/AC circuits include the first DC/AC circuit that includes the first switching circuit (the switching circuit 1) and the capacitor C1 connected in parallel to the first switching circuit (the switching circuit 1), and the second DC/AC circuit that includes the second switching circuit (the switching circuit 2) connected to a power storage unit (the storage battery V2). When power is supplied from the second DC/AC circuit to the load L connected to the DC/AC circuit (the AC/DC circuit 3) other than the first DC/AC circuit and the first switching circuit (switching circuit 1) is unloaded or a connected load is equal to or less than a predetermined power consumption value, the first switching circuit (the switching circuit 1) is switched to provide a period for supplying power from the capacitor C1 to the first switching circuit (the switching circuit 1) along with switching of the second switching circuit (the switching circuit 2).

More specifically, the first switching circuit (the switching circuit 1) is switched so that power is supplied from the first switching circuit (the switching circuit 1) to the DC/AC circuit (AC/DC circuit 3) other than the first and second DC/AC circuits.

By switching the first switching circuit (the switching circuit 1), overcharge of the capacitor C1 of the DC unit with no load can be prevented without an additional circuit such as a discharge resistor. Further, power can be returned to the original load L such as the AC/DC circuit 3. That is, by switching the unloaded circuit to transition to an operation mode in which discharge is performed from the DC unit of the unloaded circuit, net inflow energy to the unloaded DC unit can be set to zero.

The first switching circuit (the switching circuit 1) includes a semiconductor switch including a reverse diode. When the first switching circuit (the switching circuit 1) is unloaded or a connected load is equal to or less than a predetermined power consumption value, the semiconductor switch is turned on during a period in which a current flows to the reverse diode.

By turning on during conduction of the diode, switching is performed at a zero voltage. Therefore, the loss is low.

When the first switching circuit (the switching circuit 1) is unloaded or a connected load is equal to or less than a predetermined power consumption value, the semiconductor switch is turned off during a period in which a current flows to the semiconductor switch in a direction opposite to the reverse diode.

When the current is reversed from the reverse diode, the capacitor C1 of the unloaded circuit is discharged for the first time. Accordingly, when this period is provided to some extent and then the switch is turned off, a certain amount of energy is discharged from the capacitor C1.

The first switching circuit (the switching circuit 1) is a full-bridge circuit including a first leg in which the first switching element Q1 and the second switching element Q2 are upper and lower arms, and a second leg in which the third switching element Q3 and the fourth switching element Q4 are upper and lower arms. When the first switching circuit (the switching circuit 1) is unloaded or a connected load is equal to or less than a predetermined power consumption value, either the first switching element Q1 and the fourth switching element Q4 or the second switching element Q2 and the third switching element Q3 are simultaneously turned on, and one of either the first switching element Q1 and the fourth switching element Q4 or the second switching element Q2 and the third switching element Q3 is first turned off.

In the full-bridge circuit, by first turning off only one of the two elements that have been turned on, the voltage applied to the reactor can be reduced. Therefore, the current can be kept small. By this method, the current value of the first switching circuit (switching circuit 1) can be reduced, and the conduction loss can be reduced.

When the first switching circuit (the switching circuit 1) is unloaded or a connected load is equal to or less than a predetermined power consumption value, the first switching circuit (the switching circuit 1) is switched continuously so that the voltage of the capacitor C1 is constant.

As illustrated in FIG. 4A, when a pulse width of the first switching circuit (the switching circuit 1) is controlled with a voltage value of the capacitor C1 of the unloaded circuit, the voltage value can be controlled to be constant.

When the first switching circuit (the switching circuit 1) is unloaded or a connected load is equal to or less than a predetermined power consumption value and the voltage of the capacitor C1 exceeds a predetermined threshold, the first switching circuit (the switching circuit 1) is switched.

As illustrated in FIG. 4B, an overvoltage of the capacitor C1 of the unloaded circuit can be prevented by switching the first switching circuit (the switching circuit 1) only when the voltage value of the capacitor C1 of the unloaded circuit exceeds the threshold.

### Second Embodiment

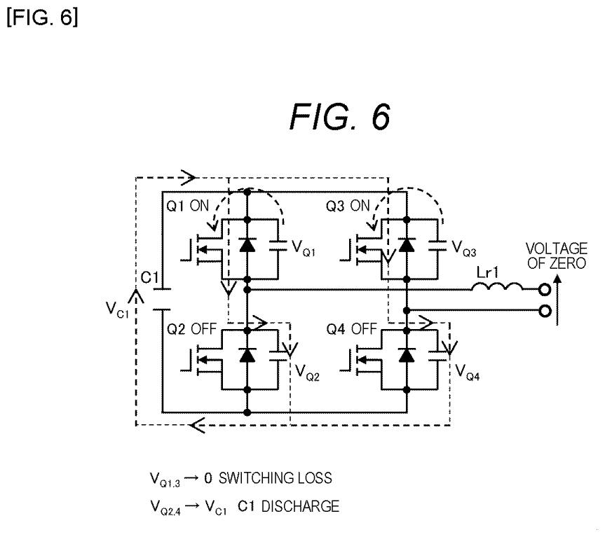

An integrated power supply device and a control method therefor according to a second embodiment of the present invention will be described with reference to FIGS. 5 and 6.

FIG. 5 is a timing chart illustrating operations of the switching circuit 1 and the switching circuit 2 according to the present embodiment.

Q1 to Q8 indicate ON/OFF states of the switching elements Q1 to Q8, and V_{TR} indicates a voltage applied to the transformer 10. As illustrated in FIG. 1, the switching elements Q5 to Q8 are switching elements for supplying power from the storage battery V2 to the load L.

In FIG. 5, the DC/DC converter 6 is assumed to be a phase shift type converter, but this is not necessarily the case.

A characteristic of the present embodiment is a relationship between a transformer-applied voltage V_{TR} and the ON timings of the switching elements Q1 to Q4. That is, an ON period of the switching elements Q1 and Q3 is provided in a period in which the transformer-applied voltage V_{TR} is zero.

Unlike the first embodiment, this operation is an operation in which energy of the capacitor C1 of the switching circuit 1 is consumed not by the load L but by the switching circuit 1. Accordingly, the operation is performed during a period in which the transformer-applied voltage V_{TR} is zero. This is because when the transformer-applied voltage V_{TR} is zero, there is no power coming and going through the transformer 10.

In the present embodiment, as illustrated in FIG. 6, the switching elements Q1 and Q3 are turned on to short-circuit output capacitances of the switching elements Q1 and Q3, and thus charging energy of the capacitor C1 is consumed (voltages V_{Q1}, V_{Q3}→0).

In FIG. 5, the switching elements Q1 and Q3 are simultaneously turned on, but any switching element may be turned on as long as the switching element is a switching element whose output capacitance is charged. However, the switching elements Q1 and Q2 or the switching elements Q3 and Q4 may not be turned on at the same time. This is because arm short-circuiting occurs at this time.

In the present embodiment, the power is consumed when the switching element is turned on. Therefore, the power consumption control, that is, voltage control of the capacitor C1, is performed by the number of times the switching element is turned on per unit time.

Like the first embodiment, the voltage of the capacitor C1 is controlled in accordance with the scheme of controlling the pulse width so that the voltage of the capacitor C1 in FIG. 4A is constant or the scheme of performing switching only when the voltage of the capacitor C1 in FIG. 4B exceeds the threshold.

As described above, the integrated power supply device (the bidirectional charging device 7) according to the present embodiment is an integrated power supply device in which each AC side of three or more DC/AC circuits is coupled by a transformer 10 having three or more windings, similarly to the first embodiment (FIG. 1), the three or more DC/AC circuits include a first DC/AC circuit that includes a first switching circuit (the switching circuit 1) and the capacitor C1 connected in parallel to the first switching circuit (the switching circuit 1), and a second DC/AC circuit that includes a second switching circuit (the switching circuit 2) connected to a power storage unit (the storage battery V2). When power is supplied from the second DC/AC circuit to the load L connected to a DC/AC circuit (the AC/DC circuit 3) other than the first DC/AC circuit, and the first switching circuit (the switching circuit 1) is unloaded or a connected load is equal to or less than a predetermined power consumption value, the first switching circuit (the switching circuit 1) is switched to provide a period for supplying power from the capacitor C1 to the first switching circuit (the switching circuit 1) along with switching of the second switching circuit (the switching circuit 2).

More specifically, when the first switching circuit (switching circuit 1) is unloaded or a connected load is equal to or less than a predetermined power consumption value, power supplied from the capacitor C1 is consumed by the first switching circuit (the switching circuit 1).

The first switching circuit (the switching circuit 1) is a bridge circuit that includes the switching element Q1 or Q3 of the upper arm and the switching element Q2 or Q4 of the lower arm. When the first switching circuit (switching circuit 1) is unloaded or a connected load is a predetermined power consumption value or less, the switching element Q1 or Q3 of the upper arm or the switching element Q2 or Q4 of the lower arm is turned on in a period in which no voltage is applied to the transformer 10.

The first switching circuit (the switching circuit 1) is a bridge circuit that includes the switching element Q1 or Q3 of the upper arm and the switching element Q2 or Q4 of the lower arm. When the first switching circuit (the switching circuit 1) is unloaded or a connected load is a predetermined power consumption value or less, the switching element Q1 or Q3 of the upper arm or the switching element Q2 or Q4 of the lower arm is turned off in a period in which no voltage is applied to the transformer 10.

When a current flows to the transformer during application of the transformer voltage, energy is moved through the transformer. Therefore, the operation according to the first embodiment or the operation of charging the capacitor C1 with no load is performed and is different from the gist of the present embodiment (consumed by the first switching circuit). Therefore, the ON period of the switch is defined as a period in which no voltage is applied to the transformer.

The present invention is not limited to the above-described embodiments and includes various modifications. For example, the above-described embodiments have been described in detail to facilitate understanding of the present invention, and are not necessarily limited to those having all the described configurations. Some of the configurations of a certain embodiment can be replaced with the configurations of another embodiment, and the configurations of another embodiment can be added to the configurations of a certain embodiment. It is possible to add, delete, and replace other configurations to, from, and with some of the configurations of each embodiment.

### Reference Signs List

1, 2 switching circuit
3 AC/DC circuit
4 AC/DC converter
5 AC power supply
6 DC/DC converter
7 bidirectional charging device
8 power supply (power flow)
10 transformer
C1, C2, Cr1, Cr2 capacitor
L load
Lm excitation inductance
Lr1, Lr2 Reactor
N1, N2, N3 winding
Q1, Q2, Q3, Q4, Q5, Q6, Q7, Q8 switching element
V2 storage battery
V_{TR} transformer-applied voltage

1. An integrated power supply device in which AC sides of three or more DC/AC circuits are coupled by a transformer having three or more windings,
wherein the three or more DC/AC circuits include a first DC/AC circuit that includes a first switching circuit and a capacitor connected in parallel to the first switching circuit and a second DC/AC circuit that includes a second switching circuit connected to a power storage unit,
wherein, when power is supplied from the second DC/AC circuit to a load connected to a DC/AC circuit other than the first DC/AC circuit and the first switching circuit is unloaded or a connected load is equal to or less than a predetermined power consumption value, the first switching circuit is switched to provide a period for supplying power from the capacitor to the first switching circuit along with switching of the second switching circuit.

2. The integrated power supply device according to claim 1, wherein, when the first switching circuit is unloaded or a connected load is equal to or less than a predetermined power consumption value,
the first switching circuit is switched to supply power from the first switching circuit to the DC/AC circuit other than the first and second DC/AC circuits.

3. The integrated power supply device according to claim 2, wherein the first switching circuit includes a semiconductor switch including a reverse diode, and
wherein, when the first switching circuit is unloaded or a connected load is equal to or less than a predetermined power consumption value, the semiconductor switch is turned on during a period in which a current flows to the reverse diode.

4. The integrated power supply device according to claim 3, wherein, when the first switching circuit is unloaded or a connected load is equal to or less than a predetermined power consumption value,
the semiconductor switch is turned off during a period in which a current flows in the semiconductor switch in a direction opposite to the reverse diode.

5. The integrated power supply device according to claim 3,
wherein the first switching circuit is a full-bridge circuit including a first leg in which first and second switching elements are set as upper and lower arms, and a second leg in which third and fourth switching elements are set as upper and lower arms, and
wherein, when the first switching circuit is unloaded or a connected load is equal to or less than a predetermined power consumption value,
either the first and fourth switching elements or the second and third switching elements are simultaneously turned on, and
one of either the first and fourth switching elements or the second and third switching elements is first turned off.

6. The integrated power supply device according to claim 1, wherein, when the first switching circuit is unloaded or a connected load is equal to or less than a predetermined power consumption value,
the first switching circuit consumes power supplied from the capacitor.

7. The integrated power supply device according to claim 6, wherein the first switching circuit is a bridge circuit including a switching element of an upper arm and a switching element of a lower arm, and
wherein, when the first switching circuit is unloaded or a connected load is equal to or less than a predetermined power consumption value,
the switching element of the upper arm or the switching element of the lower arm is turned on during a period in which no voltage is applied to the transformer.

8. The integrated power supply device according to claim 6, wherein the first switching circuit is a bridge circuit including a switching element of an upper arm and a switching element of a lower arm, and
wherein, when the first switching circuit is unloaded or a connected load is equal to or less than a predetermined power consumption value,
the switching element of the upper arm or the switching element of the lower arm is turned off during a period in which no voltage is applied to the transformer.

9. The integrated power supply device according to claim 1, wherein when the first switching circuit is unloaded or a connected load is equal to or less than a predetermined power consumption value,
the first switching circuit is switched continuously so that the voltage of the capacitor is constant.

10. The integrated power supply device according to claim 1, wherein, when the first switching circuit is unloaded or a connected load is equal to or less than a predetermined power consumption value and a voltage of the capacitor exceeds a predetermined threshold,
the first switching circuit is switched.

11. A control method for an integrated power supply device in which AC sides of three or more DC/AC circuits including a first DC/AC circuit on a primary side and a second DC/AC circuit on a secondary side are coupled by a transformer having three or more windings,
wherein, when power is supplied from the second DC/AC circuit to a load connected to a DC/AC circuit other than the first DC/AC circuit and the first switching circuit of the first DC/AC circuit is unloaded or a connected load is equal to or less than a predetermined power consumption value,
the first switching circuit is switched to provide a period for supplying power from a capacitor connected in parallel to the first switching circuit to the first switching circuit along with switching of the second switching circuit of the second DC/AC circuit.

12. The control method for the integrated power supply device according to claim 11, wherein, when the first switching circuit is unloaded or a connected load is equal to or less than a predetermined power consumption value,
the first switching circuit is switched to supply power from the first switching circuit to the DC/AC circuit other than the first and second DC/AC circuits.

13. The control method for the integrated power supply device according to claim 12, wherein the first switching circuit includes a semiconductor switch including a reverse diode, and
wherein, when the first switching circuit is unloaded or a connected load is equal to or less than a predetermined power consumption value, the semiconductor switch is turned on during a period in which a current flows to the reverse diode.

14. The control method for the integrated power supply device according to claim 13, wherein, when the first switching circuit is unloaded or a connected load is equal to or less than a predetermined power consumption value,
the semiconductor switch is turned off during a period in which a current flows in the semiconductor switch in a direction opposite to the reverse diode.
